(19) United States
(12) Patent Application Publication
(10) Pub. No.: US 2003/0106793 A1
(43) Pub. Date: Jun. 12, 2003

(54) Electrode for plasma processing system

(76) Inventors: Murray D. Sirkis, Tempe, AZ (US); Eric Strang, Chandler, AZ (US)

Correspondence Address: PILLSBURY WINTHROP, LLP, P.O. BOX 10500, MCLEAN, VA, 22102, US

(21) Appl. No.: 10/345,290

(22) Filed: Jan. 16, 2003

Related U.S. Application Data
(63) Continuation of application No. PCT/US01/22509, filed on Jul. 19, 2001.
(60) Provisional application No. 60/219,735, filed on Jul. 20, 2000.

(51) Int. Cl. B01J 19/08

(52) U.S. Cl. 204/297.01; 422/186; 422/186.04

(57) ABSTRACT

A plasma processing system (110) includes an electrode assembly (150) having a metal drive electrode (154) coupled to a source electrode (152). Source electrode (152) is further provided with an insulating layer (151) on its backside face. The insulating layer (151) is the contact layer between metal drive electrode (154) and source electrode (152). Additionally, source electrode (152) is provided with various front face contours (261, 262, 263, 264). The front face of source electrode (152) is exposed to the reactor chamber 142 of plasma processing system (110) during use. The source electrode is attached to metal drive electrode (154) using fasteners (133) that do not introduce contaminants into the plasma processing chamber.

### CROSS REFERENCE TO RELATED CO-PENDING APPLICATIONS

This a Continuation of International Application No. PCT/US01/22509, which was filed on Jul. 19, 2001 and claims priority from Provisional U.S. Application No. 60/219,735, which was filed Jul. 20, 2000. This application is also related to Provisional U.S. application No. 60/219,453, which was filed on Jul. 20, 2000, entitled ELECTRODE APPARATUS AND METHOD FOR PLASMA PROCESSING, the contents of which are expressly incorporated herein by reference.

### BACKGROUND OF THE INVENTION

The present invention relates to the field of plasma processing of silicon wafers and more particularly to an improved electrode assembly for use in plasma processing equipment.

As is known in the art, a fundamental step in the manufacturing of semiconductor devices, such as integrated circuits (ICs) is the process of forming electrical interconnections. The formation of electrical circuits, such as semiconductor transistors, involves a series of steps starting with the formation of a silicon wafer. The silicon wafer is then processed using successive steps of depositing and etching various materials to form the proper interconnections and therefore the electrical circuits.

Methods of depositing material layers on and etching material layers from a silicon wafer are carried out in a so-called plasma reactor system. In semiconductor manufacturing, plasma reactor systems are used to remove or deposit material to or from a workpiece (e.g. semiconductor substrate) in the process of making IC devices. A key factor in obtaining the highest yield and overall quality of ICs is the uniformity of the etching and deposition processes.

There are several different kinds of plasma processes used during wafer processing. These processes include: (1) plasma etching, (2) plasma deposition, (3) plasma assisted photo resist stripping and (4) in-situ plasma chamber cleaning. Particularly in high frequency capacitively coupled plasma reactors, each of these plasma processes can have associated plasma density non-uniformities due to a non-uniform RF field resulting from the generation of harmonics of the plasma excitation frequency. A non-uniform plasma can non-uniformly erode the consumable silicon electrode conventionally used as a protective layer on the RF electrode in plasma processing. The non-uniformly etched silicon electrode in turn exacerbates the non-uniformity of the plasma. To ensure uniform plasma, these silicon electrodes are changed frequently. If a system with a non-uniform plasma is used for semiconductor wafer processing, the non-uniform plasma can produce non-uniform etching or deposition on the surface of the semiconductor wafers. Thus, the control of uniform etching of the silicon electrode directly affects the quality of integrated circuits manufactured by the semiconductor industry.

When it is desired to deposit materials onto a semiconductor wafer, a plasma reactor is sometimes used to sputter a variety of materials, one of which can be silicon, onto the wafer. In these sputtering applications, a silicon disk, silicon dioxide disk or doped-silicon disk is used as a target on a metal drive electrode to provide a source of material to be deposited on a surface of the semiconductor wafer to form the desired wafer topography.

A problem that has plagued prior art plasma reactors is the control of the plasma to obtain uniform workpiece etching and deposition. In plasma reactors, the degree of etch or deposition uniformity is determined by the uniformity of the plasma density profile. The latter is dictated by the design of the overall system, and in particular the design of the electrode assembly used to create the plasma in the interior region of the reactor chamber.

As illustrated in FIG. 1, a typical plasma reactor system 10 is shown to include, inter alia, a plasma chamber 11 in which a silicon wafer 18 is processed. Silicon wafer 18 is placed on a chuck 16 and exposed to a process-specific plasma depending on whether the wafer is undergoing an etch or deposition step. The plasma within chamber 11 is formed by electro-mechanically coupling a silicon electrode 14 to a metal drive electrode 12 and driving a RF signal through metal electrode 12 and consequently through silicon electrode 14. Silicon electrode 14, in effect, becomes the electrode in direct physical and electrical contact with the plasma. The plasma formed within chamber 11 depends upon a variety of factors including the RF power magnitude, the gas used to fill chamber 11, and the composition of source electrode 14. During processing of silicon wafers, a silicon disk can be used as the source electrode. Silicon electrode 14 is consumed during the process and therefore must be changed periodically in order to maintain consistent processing conditions with plasma chamber 11.

In prior art systems such as system 10 of FIG. 1, silicon electrode 14 is typically attached to metal drive electrode 12 by means of metal screws 23. Metal screws 23 pass through clearance holes in silicon electrode 14 and mate with threaded holes in metal drive electrode 12 or mate with a metal nut 25 on the back side of metal drive electrode 12. The clearance holes in the silicon electrode are countersunk to assure that the heads of the metal screws 23 do not protrude beyond the face of source electrode 14 that is exposed to the chamber 11. Due to the electrical, thermal and physical contact requirements between silicon electrode 14 and metal drive electrode 12, there is a need to ensure a proper connection between the two.

To achieve proper electrical, thermal and physical contact between silicon electrode 14 and metal drive electrode 12, metal screws 23 for the silicon electrode are tightened to a specified torque of 1.3 to 3.5 in-lb. Even when screws 23 are tightened to an acceptable torque rating, the electromechanical contact is generally poor and unrepeatable. This poor contact results in plasma process variation each time silicon electrode 14 is replaced.

In addition to the problems associated with attaching silicon electrode 14 to metal drive electrode 12, there is another problem associated with maintaining plasma uniformity due to the manner in which drive electrode 12 erodes during use. As described above, silicon electrode 14 is consumed during plasma processing. Typically, the silicon electrode 14 is designed to have a substantially planar shape. However, during processing, silicon electrode 14 does not erode uniformly across its exposed planar surface. This non-uniform erosion results in a change in the contour of the exposed face of silicon electrode 14. The shape of the exposed face of silicon electrode 14 affects the plasma produced in chamber 11 and thus the plasma uniformity changes as the contour changes.

It would be advantageous therefore to provide an apparatus for plasma processing of semiconductor wafers that allows for secure, repeatable attachment of a silicon electrode to a metal drive electrode while providing a good electrical connection to the drive electrode. It would also be advantageous to provide a silicon drive electrode that compensates for non-uniform erosion during plasma processing.

### BRIEF SUMMARY OF THE INVENTION

The present invention provides an electrode assembly for use in a plasma processing system having an improved electrical interface between the source electrode and the metal drive electrode. The improved interface is generated by depositing a layer of oxide on to one face of the source electrode. The source electrode is then mounted to the drive electrode such that the oxide layer is in contact with the metal face of the drive electrode. This configuration isolates the silicon base material from the metal drive electrode. When RF energy is applied to the metal drive electrode, the base material of the source electrode (e.g. silicon) is capacitively coupled to the drive electrode allowing the desired potential to be created between the source electrode and the workpiece that has been loaded into the chamber of the plasma processing system. With such an arrangement, a reliable, repeatable electrical interface is provided between the drive electrode and the source electrode since reliance on a physical coupling for an electrical connection has been eliminated. Also, since the physical contact requirements are loosened, a less robust mounting system may be used to attach the source electrode to the drive electrode. For example, non-metallic bolts can be used to replace previously required metallic bolts. This further leads to a reduction in contamination in the reactor chamber.

The present invention also provides an improved source electrode that aids in maintaining plasma uniformity during repeated or prolonged use. In particular, the improved electrode can have the oxide layer described above in combination with the additional feature of a contoured face. The contour is provided on the face of the electrode that is exposed to the plasma chamber during processing (i.e. the face opposite the oxide layer face). The contour can be a convex or concave profile over all or a portion of the exposed face of the source electrode. Additional profiles can also be provided.

### BRIEF DESCRIPTION OF THE SEVERAL VIEWS OF THE DRAWING

The above described and other features of the present invention will be described while referring to the accompanying drawings in which:

FIG. 1 is a diagrammatic elevational representation of a prior art plasma deposition and etching system;

FIG. 2 is a diagrammatic elevational representation of a preferred embodiment of a plasma deposition and etching system according to the present invention;

FIG. 2A is a bottom plan view of the plasma contacting surface of the source electrode of the plasma processing deposition and etching system of FIG. 2;

FIG. 3 is an elevational view of another embodiment of a source electrode of the plasma deposition and etching system of FIG. 2;

FIGS. 4A, 5A, 6A and 7A are isometric views of alternate embodiments of the source electrode of the plasma deposition and etching system of FIG. 2;

FIGS. 4B, 5B, 6B and 7B are sectional views along lines 4B-4B, 5B-5B, 6B-6B and 7B-7B of FIGS. 4A, 5A, 6A and 7A, respectively.

FIGS. 8A, 8B, 8C and 8D depict sectional views of the source electrode of FIG. 4A undergoing process steps to form its associated contour; and

FIGS. 9A and 9B are elevational views of alternate source electrodes of the plasma deposition and etching system of FIG. 2.

### DETAILED DESCRIPTION OF THE INVENTION

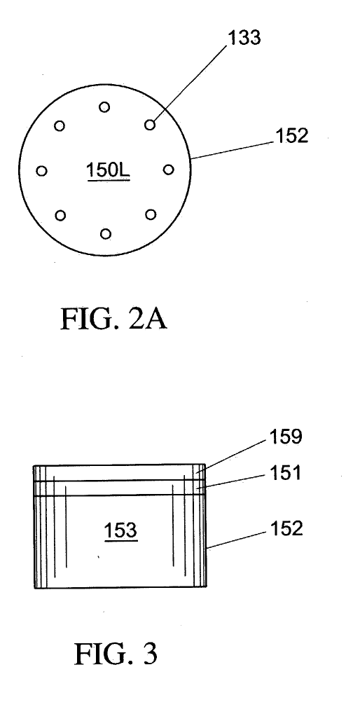

Referring now to FIG. 2, a plasma processing system 110 is shown to include, inter alia, a plasma chamber 120 that functions as a vacuum processing chamber adapted to perform plasma etching from and material deposition on workpiece W. Here, workpiece W is a semiconductor wafer, such as silicon, and has an upper surface WS. Chamber 120 includes sidewalls 122, an upper wall 124 and a lower wall 126 that enclose an interior region 142 capable of supporting plasma 136. Chamber 120 further includes within region 142, a workpiece support 140 arranged adjacent lower wall 126 for supporting workpiece W while the workpiece is processed in chamber 120. As mentioned above, workpiece W can be a semiconductor substrate, such as silicon, on which patterns have been formed and where the patterns correspond to product devices (e.g. electronic circuits). Workpiece W can also be a bare semiconductor substrate that requires plasma cleaning, metal deposition or photoresist etching, etc.

Chamber 120 of system 110 includes an electrode assembly 150 arranged within interior region 142 adjacent workpiece support 140. Electrode assembly 150 is preferably capacitively coupled to workpiece W when the workpiece is being plasma processed. Electrode assembly 150 includes an upper surface 150U facing away from workpiece support 140 and a lower surface 150L facing towards workpiece support 140. Electrode 150 serves to further divide plasma chamber interior region 142 into an upper section 142U between chamber wall 124 and upper electrode surface 150U, and a lower section 142L between lower electrode surface 150L and lower chamber wall 126, lower section 142 being isolated from upper section 142U. Plasma 136 is formed in lower section 142L of interior region 142. Plasma 136 ideally has a plasma density (i.e., number of ions/volume, along with energy/ion) that is uniform, unless the density needs to be tailored to account for other sources of process non-uniformities. The density of plasma 136 has a spatial distribution above the wafer referred to herein as a “plasma density profile”.

As will be described in more detail below, electrode assembly 150 further includes a metal drive electrode 154 which has coupled thereto a source electrode 152 having an upper surface 152U and a lower surface 152L. Upper surface 152U is the contact point between source electrode 152 and metal drive electrode 154. According to the present invention, source electrode 152 can include an oxide layer 151 on a surface of a silicon portion 153 of source electrode 152 thereby creating a metal-to-oxide interface where drive electrode 154 meets source electrode 152.

Electrode assembly 150 can be electrically connected to a RF power supply system 162. RF power supply 162 can have coupled thereto an associated match network MN to match the impedance of electrode assembly 150 and the associated excited plasma 136 to the source impedance of RF power supply system 162, thereby increasing the maximum power that may be delivered by the RF power supply 162 to the plasma electrode assembly 150 and the associated excited plasma 136. The plasma density of plasma 136 increases as the power delivered by RF power supply 162 to plasma 136 increases. Hence, for a given RF power supply system 162, the maximum attainable plasma density of plasma 136 is increased by means of the matching network. Moreover, workpiece holder 140 used to support wafer W can have a RF power supply 164 coupled thereto to bias the wafer W. A RF bias can be applied to wafer support 140 through a match network MN from RF generator 164.

Still referring to FIG. 2, plasma processing system 110 further includes a gas supply system 180 in pneumatic communication with plasma chamber 120 via one or more gas conduits 182 for supplying gas in a regulated manner to form plasma 136. Gas supply system 180 supplies such gases as chlorine, hydrogen-bromide, octaflourocyclobutane, and various other fluorocarbon compounds, and for chemical vapor deposition applications supplies silane, tungsten-tetrachloride, titanium-tetrachloride, and the like.

Plasma processing system 110 also includes a vacuum system 190 connected to chamber 120 for evacuating interior region section 142L to a pressure that depends on the nature of the plasma desired.

Plasma processing system 110 can further include a workpiece handling and robotic system 194 in operative communication with chamber 120 for transporting workpieces W to and from workpiece support 140. In addition, a cooling system 196 in fluid communication with electrode assembly 150 is preferably included for flowing a cooling fluid to and from the electrode.

Plasma processing system 110 can further include a main control system 200 to which RF power supply systems 162 and 164, gas supply system 180, vacuum pump system 190 and work piece handling and robotic system 194 are electronically connected. In the preferred embodiment, main control system 200 is a computer having a memory unit MU having both a random access memory (RAM) and a read-only memory (ROM), a central processing unit CPU, and a hard disk HD, all electronically connected. Hard disk HD serves as a secondary computer-readable storage medium, and can be for example, a hard disk drive for storing information corresponding to instructions for controlling plasma system 110. Control system 200 also preferably includes a disk drive DD, electronically connected to hard disk HD, memory unit MU and central processing unit CPU, wherein the disk drive is capable of reading and/or writing to a computer-readable medium CRM, such as a floppy disk or compact disc (CD) on which is stored information corresponding to instructions for control system 200 to control the operation of plasma system 120.

It is also preferable that main control system 200 has data acquisition and control capability. A preferred control system 200 is a computer, such as a DELL PRECISION WORKSTATION 610™, available from Dell Computer Corporation, Dallas, Tex. As will be appreciated by those of skill in the art, data acquisition and control can be facilitated by coupling the electronic control systems associated with each of the subsystems 162, 164, 180, 190, 194, and 196 mentioned above via the workstation's serial or parallel ports or can require additional hardware (not shown) coupled between main control system 200 and subsystems 162, 164, 180, 190, 194 and 196. All of the systems described above can be constructed according to principles know in the art.

Electrode Assembly

According to the present invention, an electrode assembly is provided for use in a plasma processing system that allows a source electrode to be fastened to a drive electrode in a manner that provides dc isolation between the two. Referring again to FIG. 2, a preferred embodiment of electrode assembly 150 will be discussed. Source electrode 152, which is here made of silicon, includes an oxide layer 151 on the backside or upper surface of base material 153 of source electrode 152. Oxide layer 151 in turn provides the upper surface 152U (i.e. contact surface) of source electrode 152. Oxide layer 151 can be provided by any of a group of well-known physical deposition procedures, such as quartz sputtering or TEOS deposition. Oxide layer 151 can have a thickness that is typically on the order of one to ten microns. By providing an oxide layer as the interface between metal drive electrode 154 and source electrode 152, an electrically insulated connection between the two is achieved. With oxide layer 151, source electrode 152 becomes a passive electrical component of plasma processing system 110.

During operation of plasma system 110, RF energy applied to metal drive electrode 154 is capacitively coupled to source electrode 152 thereby providing the required electrical potential between source electrode 152 and workpiece W to enable the formation of plasma 136. More particularly, a displacement current flows between the effective capacitor plates (metal drive electrode 154 and source electrode 152) to cause the desired electrical coupling between metal drive electrode 154 and source electrode 152. Assuming a relatively constant surface area associated with source electrode 152 and metal drive electrode 154, the magnitude of the capacitance associated with electrode assembly 150 is determined by the thickness of oxide layer 151. Therefore, controlling the thickness of oxide layer 151 allows for easy and accurate control of the electrical characteristics of electrode assembly 150. Oxide layer 151 should be free of pinholes and/or be sufficiently thick to prevent voltage breakdown between metal drive electrode 154 and silicon electrode base material 153.

In addition to the enhanced electrical characteristics associated with providing oxide layer 151 on source electrode 152, elimination of the metal-to-semiconductor contact (i.e. electrically conducting contact) results in a reduction in the force required to maintain a repeatable and reliable coupling between the two. As shown in FIG. 2, source electrode 152 can be coupled to metal drive electrode 151 with a plurality of threaded fasteners or bolts 130 inserted and coupled to mating insert sleeves 132. Here, insert sleeves 132 are preferably constructed of a non-reactive material such as polytetrafluoroethylene (PTFE) and include a retaining portion 133 that is drawn against surface 150L of electrode assembly 150 in response to threading of fastener 130 into insert sleeve 132. Other materials such as Nylon, Vespel® or Delrin® can be used for insert sleeve 132 instead of PTFE. The material chosen should possess approximately the same properties as PTFE in terms of strength and reactivity during plasma processing. Insert sleeves 132 are preferably inserted through holes in source electrode 152 and corresponding holes in metal drive electrode 154. Also, according to the preferred embodiment, each insert sleeve 132 is tapered on the outer diameter and along its longitudinal axis.

More specifically, each insert sleeve 132 can be tapered on the outer diameter and along its longitudinal axis, wherein the outer diameter increases from the bottom, adjacent retaining portion 133, to the top, adjacent fastener 130. Two diametrically opposite slits can be formed in sleeve 132 to extend in a direction along its longitudinal axis. For insertion into associated holes in electrodes 152 and 154, sleeve 132 can be depressed radially inwardly, or squeezed, in the direction to narrow the slits. The slits can extend along the length of the internally threaded section 158 of sleeve 132 or they can extend further along the sleeve if the slit or cut extends through the centerline of the sleeve. Once sleeve 132 is inserted, radially outward expansion of the sleeve will hold it in place by means of friction, i.e. sleeve 132 will not fall out of the hole when threaded fastener 130 is inserted into internally threaded section 158 of sleeve 132. Such a form of construction for each sleeve 132 is disclosed in Provisional U.S. application No. 60/219,453, filed Jul. 20, 2000 cited earlier herein, the contents of which have already been incorporated herein by reference. That application No. 60/219,453 discloses other embodiments of sleeves 132 that can be employed in systems according to the present invention.

As shown in FIG. 2A, the preferred embodiment of electrode assembly 150 includes a plurality of threaded inserts 132 (FIG. 2) spaced azimuthally about the proximate perimeter of source electrode 152 (where in FIG. 2A, only associated retaining portions 133 are visible). Here, eight inserts are shown with their associated retaining portions 133. However, additional or fewer bolt/fastener combinations can be employed depending on the particular system construction.

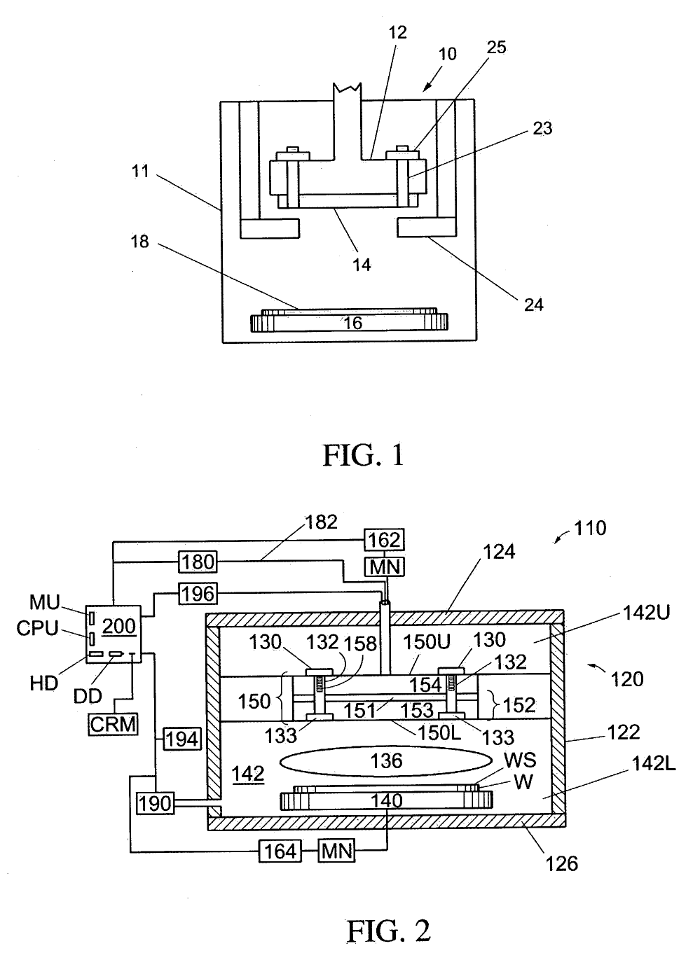

Insert sleeves 132 of the preferred embodiment play two important roles. Insert sleeves 132 expand laterally as threaded fasteners 130 are screwed into them to draw source electrode 152 into contact with metal drive electrode 154. Consequently, friction force between sleeves 132 and the mounting holes prevent insert sleeves 132 from rotating within their respective mounting holes when the torque applied to threaded fasteners 130 increases. Alternatively, insert sleeves 132 could be provided with a square section recessed into a square hole (or, more generally, a non-circular section recessed in a correspondingly shaped hole). In addition to their expansion capabilities, insert sleeves 132 are made of a non-reactive material, which eliminates contamination due to the prior art metal screws and the quartz shield ring described above in connection with FIG. 1. The use of insert sleeves 132 isolates threaded fasteners 130 completely from the vacuum chamber 120 and thus eliminates the need for a quartz shield ring.

As an alternative to the threaded fastener/insert sleeve combination described above, metal drive electrode 154 can be provided with threaded mounting holes in place of the smooth bore holes described above. Then, insert sleeves 132 can be replaced with bolts constructed of the same material as insert sleeves 132 (e.g. PTFE), while having a thread which mates with the threaded mounting holes in metal drive electrode 154. With this arrangement, the source electrode can be secured to the metal drive electrode 152 by passing the threaded bolts through holes in the source electrode 152 and securing them to corresponding threaded holes in drive electrode 154. Tightening the bolts causes the associated bolt heads to bear against surface 150L of source electrode 152 and draw source electrode and metal drive electrode 154 together. If an insulating material chosen for the fastening bolts is not compatible with the plasma process, then the standard quartz shield ring can be employed to cover the bolt ends.

Referring now to FIG. 3, an alternate embodiment of electrode assembly 150 is shown to include a silicon source electrode 152 having oxide layer 151 deposited on a backside surface as described above in connection with FIG. 2. Here, a metal layer 159 is deposited on top of oxide layer 151 and serves as the interface between metal drive electrode 154 and source electrode 152. Metal layer 159 can be provided using well-known deposition techniques. Metal layer 159 provides a good electrical contact between source electrode 152 and metal drive electrode 154 without adversely affecting the insulation between the metal drive electrode and silicon base material 153. The addition of the conducting layer atop the insulation layer will minimize the probability of a voltage breakdown (i.e. arc) across the insulation layer. For example, a poor mechanical contact between the insulation layer 151 and the metal drive electrode 154 could lead to gaps across which substantial voltage differences could form, hence leading to arcing and damage to the insulation layer. Deposition of a conducting layer 159 on the insulation layer 151 can insure a very accurate and repeatable formation of a constant thickness insulation layer (i.e. repeatable capacitor design) and a good mechanical contact between the conducting and insulation layers (i.e. no gaps). The electrical coupling between the conducting layer 159 and the metal drive electrode 154 is less susceptible to the imperfections of a spatially non-homogeneous electrical contact and possible resultant detrimental effects such as arcing.

According to another aspect of the present invention, an electrode assembly for use in a plasma processing system is provided that includes a surface profile that is substantially non-planar. For example, and as will be discussed below, the surface of the source electrode that is exposed to the plasma system reactor chamber can be concave or convex in shape. By providing a non-planar exposed surface the deposition and/or etch characteristics of the plasma can be controlled.

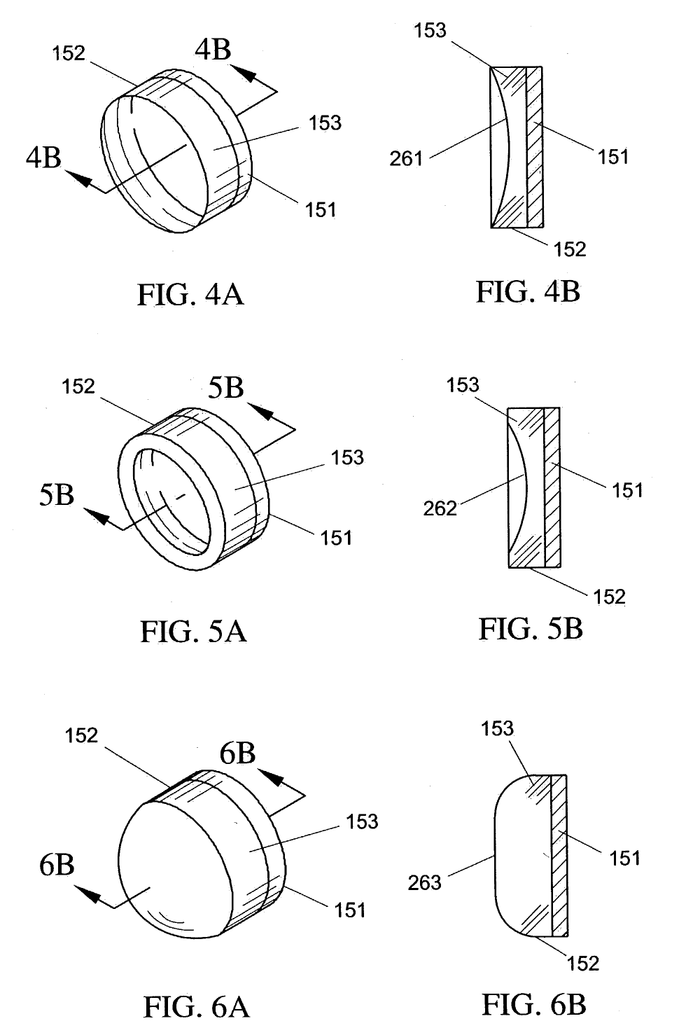

In particular and referring now to FIGS. 4A and 4B, a first embodiment of shape enhanced source electrode 152 is shown as having a base 153, which is here comprised substantially of silicon. As described earlier, the backside surface of source electrode 152 is covered with an oxide layer 151. Source electrode base 153 is provided with a generally concave portion 261 over its entire front side surface. When used as the source electrode in plasma processing system 110 (FIG. 2), concave portion 261 is that portion of drive electrode 152 that is exposed to reactor chamber 120. This type of design for source electrode 152 can be used to compensate for a high plasma density and/or etch or deposition rate at the wafer center. As a result the plasma created with electrode 152 will tend to increase the plasma density at the edge of plasma 136 and thereby increase the etch or deposition rate at the edge relative to that at the center of workpiece W (FIG. 2).

Referring now to FIGS. 5A and 5B, a second embodiment of shape enhanced source electrode 152 is shown as having a base 153, which is here comprised substantially of silicon. As described earlier, the backside surface of source electrode 152 is covered with an oxide layer 151. Source electrode base 153 is provided with a generally concave portion 262 over a portion of its front side surface. When used as the source electrode in plasma processing system 110 (FIG. 2), concave portion 262 is that portion of drive electrode 152 that is exposed to reactor chamber 120. This type of design for source electrode 152 can be used to compensate for a high plasma density and/or etch or deposition rate at the wafer center. As a result, the plasma created using electrode 152 will tend to increase the plasma density at the edge of plasma 136 and thereby increase the etch or deposition rate at the edge relative to that at the center of workpiece W (FIG. 2). The flat surface at the edge of the source electrode 152 can accommodate a smooth, flush fit between the source electrode 152 and an adjacent quartz shield ring.

Referring now to FIGS. 6A and 6B, a third embodiment of shape enhanced source electrode 152 is shown as having a base 153, which is here comprised substantially of silicon. As described earlier, the backside surface of source electrode 152 is covered with an oxide layer 151. Source electrode base 153 is provided with a generally convex portion 263 over its entire front side surface. When used as the source electrode in plasma processing system 110 (FIG. 2), concave portion 263 is that portion of drive electrode 152 that is exposed to reactor chamber 120. This type of design for electrode 152 can be used to compensate for a high plasma density and/or etch or deposition rate at the wafer edge. As a result electrode 152 will tend to increase the plasma density at the center of plasma 136 and thereby increase the etch or deposition rate at the center relative to that at the edge of workpiece W (FIG. 2).

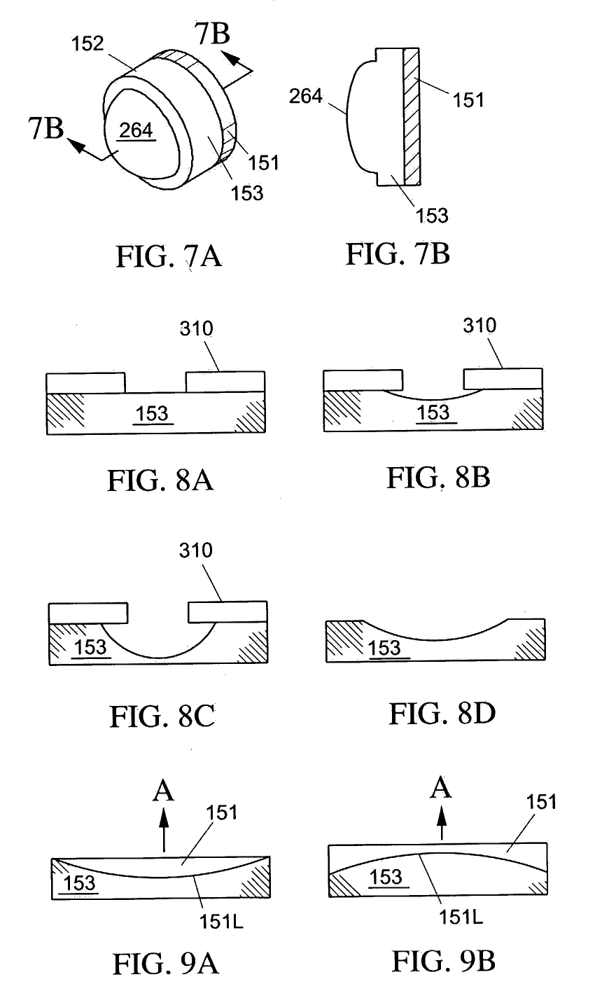

Referring now to FIGS. 7A and 7A, a fourth embodiment of shape enhanced source electrode 152 is shown as having a base 153, which is here comprised substantially of silicon. As described earlier, the backside surface of source electrode 152 is covered with an oxide layer 151. Source electrode base 153 is provided with a generally convex portion 264 over a portion of its front side surface. When used as the source electrode in plasma processing system 110 (FIG. 2), concave portion 264 is that portion of drive electrode 152 that is exposed to reactor chamber 120. This type of design for electrode 152 can be used to compensate for a high plasma density and/or etch or deposition rate at the wafer edge. As a result electrode 152 will tend to increase the plasma density at the center of plasma 136 and thereby increase the etch or deposition rate at the center relative to that at the edge of workpiece W (FIG. 2). The flat surface at the edge of the source electrode 152 can accommodate a smooth, flush fit between the source electrode 152 and an adjacent quartz shield ring. Many other configurations of surface profile can also be provided such as various combinations of concave and convex shapes along the front side surface of base material 153.

Surface portions 261, 262, 263 and 264 (FIGS. 4B-7B respectively) can be formed using any number of semiconductor processing techniques. For example, and referring now to FIGS. 8A-8D, several steps of a photolithographic and wet isotropic etching process are shown. In FIG. 8A, base 153 is shown as having a mask layer 310 deposited on the surface which is to be contoured. Mask layer 310 is formed using photolithographic techniques that are well known in the art. Base 153 with mask layer 310 is then placed in a chemical etching solution. As shown in FIG. 8B the chemical etching solution primarily etches away the material that is exposed by mask 310. Due to the isotropic nature of the etching process, the base 153 will actually be partially attacked and removed by the chemical etching solution under the edges of mask 310 as shown in FIGS. 8B and 8C. FIG. 8C depicts base 153 after extended exposure to chemical etching solution. At this point, the desired profile is achieved. As shown in FIG. 8D, once a desired profile is reached, mask 310 is stripped using well-known photoresist stripping operations. An oxide layer, as described above, can be applied to the backside surface of base 153 before the front face contour has been formed.

Referring now to FIGS. 9A and 9B, the thickness of the drive electrode can be kept constant as a function of radius, while the thickness of silicon base 153 and the thickness of oxide layer 151 (or insulation layer) can be spatially varied in complement to one another in order to affect the capacitive coupling between metal drive electrode 154 and silicon base 153. The interfacial surface 151L between silicon base 153 and oxide layer 151 can be concave relative to direction A (FIG. 9A) or convex relative to direction A (FIG. 9B), or can have some complex surface configuration. The concave or convex surface on silicon base 153 can be fabricated using techniques described above. Thereafter, oxide layer 151 can be deposited using conventional techniques or SOG (spin-on-glass techniques), and then planarized.

Although the above described electrode assembly has been described in connection with electrodes used in a plasma reactor, it should be understood that the present invention can be employed in any system where a drive electrode is coupled to a source electrode. The many features and advantages of the present invention are apparent from the detailed specification and thus, it is intended by the appended claims to cover all such features and advantages of the described apparatus which follow the true spirit and scope of the invention. Furthermore, since numerous modifications and changes will readily occur to those of skill in the art, it is not desired to limit the invention to the exact construction and operation described herein. Moreover, the process and apparatus of the present invention, like related apparatus and processes used in the semiconductor arts tend to be complex in nature and are often best practiced by empirically determining the appropriate values of the operating parameters or by conducting computer simulations to arrive at a best design for a given application. Accordingly, all suitable modifications and equivalents should be considered as falling within the spirit and scope of the invention.

What is claimed is:

1. An electrode assembly comprising:
a metal drive electrode adapted to be coupled to a source of RF energy; and
a source electrode removably coupled to said drive electrode;
wherein said source electrode comprises a disc of material for contacting a plasma and an electrical insulation layer disposed on a first face of said disc; and
said electrode assembly is arranged such that the insulation layer is in contact with a first face of said metal electrode.

2. The electrode assembly of claim 1 wherein said disc is comprised of a semiconductor material.

3. The electrode assembly of claim 1 wherein said disc is comprised of silicon.

4. The electrode assembly of claim 1 wherein said electrical insulation layer is oxidized silicon.

5. The electrode assembly of claim 1 wherein said insulation layer has a uniform thickness across said first face of said disc.

6. The electrode assembly of claim 1 wherein said insulation layer has a non-uniform thickness across said face of said disc.

7. The electrode assembly of claim 1 wherein said source electrode further comprises an electrically conducting layer disposed on said electrical insulation layer and in contact with said first face of said metal electrode.

8. The electrode assembly according to claim 7 wherein said conducting layer is comprised of nickel or aluminum.

9. A plasma processing system comprising:
a vacuum chamber;
a RF power supply; and
an electrode assembly disposed within said vacuum chamber, said electrode assembly comprising:
a metal drive electrode adapted to be coupled to a source of RF energy; and
a source electrode removably coupled to said drive electrode;
wherein said source electrode further comprises a disc of material for contacting plasma generated in said vacuum chamber and an electrical insulation layer disposed on a first face of said disc; and said electrode assembly is arranged such that the insulation layer is in contact with a first face of said metal electrode.

10. The electrode assembly of claim 9 wherein said source electrode is comprised of a semiconductor material.

11. The electrode assembly of claim 9 wherein said source electrode is comprised of silicon.

12. The electrode assembly of claim 9 wherein said electrical insulation layer is oxidized silicon.

13. The electrode assembly of claim 9 wherein said insulation layer has a uniform thickness across said first face of said disc.

14. The electrode assembly of claim 9 wherein said insulation layer has a non-uniform thickness across said face of said disc.

15. The plasma processing system of claim 10 wherein said source electrode further comprises a conducting layer disposed on said insulation layer and in contact with said first face of said metal electrode.

16. The electrode assembly according to claim 16 wherein said metal is nickel or aluminum.

17. A source electrode for attachment to a metal drive electrode in a plasma processing system comprising:
a disc of material for contacting a plasma; and
an electrical insulation layer disposed on a first face of said disc.

18. The source electrode of claim 17 wherein said disc is comprised of a semiconductor material.

19. The source electrode of claim 17 wherein said disc is comprised of silicon.

20. The source electrode of claim 17 wherein said electrical insulation layer is oxidized silicon.

21. The electrode assembly of claim 17 wherein said insulation layer has a uniform thickness across said first face of said disc.

22. The electrode assembly of claim 17 wherein said insulation layer has a non-uniform thickness across said face of said disc.

23. The source electrode of claim 17 wherein said source electrode further comprises an electrically conducting layer disposed on said insulation layer and in contact with said first face of said metal electrode.

24. The source electrode according to claim 23 wherein said conducting layer is comprised of nickel or aluminum.
